(19) United States
(12) Patent Application Publication
(10) Pub. No.: US 2003/0104193 A1
(43) Pub. Date: Jun. 5, 2003

(54) Breathable films

(76) Inventors: Jill M. Martin, Pearland, TX (US); Miguel A. Prieto, Richterswill (CH); Luis G. Zalamea, Bogota (CO)

Correspondence Address: Gregory L. Porter, VINSON & ELKINS LLP, 2300 First City Tower, 1001 Fannin, Houston, TX, 77002-6760, US

(21) Appl. No.: 10/213,355

(22) Filed: Aug. 6, 2002

Related U.S. Application Data
(60) Provisional application No. 60/310,364, filed on Aug. 6, 2001.

(51) Int. Cl. B32B 3/26

(52) U.S. Cl. 428/304.4; 428/515; 428/518; 428/519

(57) ABSTRACT

The present invention relates to breathable film compositions and processes for producing such compositions. The breathable films comprise a polyolefin continuous phase and a polystyrene dispersed phase. Said films are useful in many applications including diapers and other personal hygiene devices.

### FIELD OF THE INVENTION

The present invention relates to breathable films and processes for making such films. More particularly, the invention relates to breathable films having a polyolefin continuous phase and polystyrene dispersed phase and processes for making such films.

### BACKGROUND AND SUMMARY OF THE INVENTION

Films are often desired for use in applications that require resistance to penetration by liquids. Such applications include, for example, diapers and other personal care products. In such applications it is often desirable that the films be vapor permeable. In this manner, the diapers and other devices having the films are more comfortable to the wearer because the relative humidity and temperature within the diaper or other product can be reduced. Films which are both liquid impermeable and vapor permeable are called breathable films.

Breathable films are conventionally made by modifying a polymer so that a film prepared from the modified polymer is vapor permeable. The modification is accomplished by mixing the polymer with a substantial quantity of a high density inorganic filler such as calcium carbonate. Next the polymer-filler mixture is extruded to form a film. The film is heated and stretched to form a breathable film.

Unfortunately, when using such fillers to produce breathable films, die buildup occurs during the extrusion. The die buildup slows processing and results in part from stearic acid coated on the surface of the calcium carbonate filler. In order to reduce the die build-up, some manufacturers have sought to reduce the stearic acid associated with the filler. Unfortunately, this often results in a poorly processable film and the manufacturers are usually forced to add calcium stearate which adds to processing time and expense.

In addition, the prior art breathable films are expensive due to the compounding cost associated with the addition of the high density inorganic filler, the increased scrap rate if the film forms, holes around agglomerated filler and often the mechanical integrity of the breathable film is insufficient for some applications.

It would be desirable to discover a new breathable film which does not require a high density filler, is not costly, and has good mechanical integrity. It would be further desirable to discover a process for making such films which had reduced die buildup.

Advantageously, a new breathable film has been discovered which does not require a high density filler, is cost-effective, and has good mechanical integrity. Surprisingly, the new films have, in addition to good mechanical integrity, softness, smoothness, and slipperiness characteristics which make the films particularly useful for personal care devices. The breathable film comprises (a) from about 40 to about 98 weight percent of a polyolefin continuous phase; and (b) from about 2 to about 60 weight percent of a polystyrene dispersed phase; wherein the ratio of the melt flow rate of the polystyrene dispersed phase to the melt index of polyolefin is less than about 2.5.

Advantageously, a new process for forming a breathable film has also been discovered. The process is advantageous because, for example, dispersion of the polystyrene phase is more readily achieved compared to the calcium carbonate with potentially reduced scrap rates. The process comprises: (a) blending from about 40 to about 98 weight percent of a polyolefin with from about 2 to about 60 weight percent of a polystyrene wherein the ratio of the melt flow rate of the polystyrene dispersed phase to the melt index of polyolefin is less than about 2.5 and wherein the blending conditions are sufficient to form a blend comprising a polyolefin continuous phase and a polystyrene dispersed phase; (b) forming a blown or cast film, either fabrication can be used from the blend; and (c) stretching said film under conditions sufficient to form said breathable film.

### BRIEF DESCRIPTION OF THE DRAWINGS

FIG. 1. Viscosity as a function of temperature for resins used in blends of

Example 7 of the present invention. All viscosities measured at 0.1 s−1, comparable to the blown film extrusion rates.

FIG. 2. Micrograph at 7000 times of sample 10 of Example 7 comprising a polyolefin continuous phase and a polystyrene dispersed phase and showing spherical and elliptical domains of HIPS polystyrene dispersed in polyethylene. The WVTR is >3000 g/m2/day.

FIG. 3. Micrograph at 7000 times of sample 12 of Example 7 comprising a polyolefin continuous phase and a polystyrene dispersed phase and showing elongated domains of HIPS polystyrene dispersed in polyethylene. The WVTR is <300 g/m2/day.

### DETAILED DESCRIPTION OF THE INVENTION

Test Procedures and Definitions

Unless indicated otherwise, the following testing procedures are to be employed, each of which is incorporated herein by reference:

Density is measured in accordance with ASTM D-792. The samples are annealed at ambient conditions for 24 hours before the measurement is taken.

Elongation (%) is measured in accordance with ASTM D882. Melt index (I2), (measured in the case of the polyolefin, e.g., homogeneous linear or substantially linear ethylene polymers or low density ethylene polymer) is measured in accordance with ASTM D-1238, condition 190 C/2.16 kg (formerly known as “Condition (E)”).

Melt index (I10), (measured in the case of the polyolefin, e.g., homogeneous linear or substantially linear ethylene polymers or low density ethylene polymer) is measured in accordance with ASTM D-1238, condition 190 C/10 kg.

Melt flow rate (measured in the case of the polystyrene dispersed phase) is measured in accordance with ASTM D-1238, condition 230 C/2.16 kg (formerly known as “Condition (L)”).

Molecular weight is determined using gel permeation chromatography (GPC) on a Waters 150° C. high temperature chromatographic unit equipped with three mixed porosity columns (Polymer Laboratories 103, 104, 105, and 106), operating at a system temperature of 140° C. The solvent is 1,2,4-trichlorobenzene, from which 0.3 percent by weight solutions of the samples are prepared for injection. The flow rate is 11.0 mL/min. and the injection size is 100 microliters.

The molecular weight determination is deduced by using narrow molecular weight distribution polystyrene standards (from Polymer Laboratories) in conjunction with their elution volumes. The equivalent polyethylene molecular weights are determined by using appropriate Mark-Houwink coefficients for polyethylene and polystyrene (as described by Williams and Word in Journal of Polymer Science, Polymer Letters, Vol. 6, (621) 1968, incorporated herein by reference) to derive the following equation:

Mpolyethylene=a*(Mpolystyrene)b.

In this equation, a=0.4316 and b=1.0. Weight average molecular weight, Mw, is calculated in the usual manner according to the following formula: Mw=Σwi*Mi where wi and Mi are the weight fraction and molecular weight, respectively, of the ith fraction eluting from the GPC column.

Permeability (water vapor transmission rate or WVTR) may be measured in accordance with ASTM E-96-80 (100° F., 90% relative humidity). Alternatively, WVTR may be measured with an L80-4000 Water Permeation Tester manufactured by Lyssy AG in Zollikon, Switzerland.

The term “composition” as used herein includes a mixture of the materials which comprise the composition, as well as, products formed by the reaction or the decomposition of the materials which comprise the composition.

The term “derived from” means made or mixed from the specified materials, but not necessarily composed of a simple mixture bf those materials. Compositions “derived from” specified materials may be simple mixtures of the original materials, and may also include the reaction products of those materials, or may even be wholly composed of reaction or decomposition products of the original materials.

The term “interpolymer” means a polymer of two or more comonomers, e.g. a copolymer, terpolymer, etc.

Polystyrene Dispersed Phase

The breathable film composition of the present invention exhibits surprising and unexpected water transmission vapor rate (WTVR). The film composition generally comprises an amount of a polystyrene dispersed phase so that when the film is stretched, voids are formed in the vicinity of the dispersed particles. The voids permit the diffusion of water vapor through the film while blocking the passage of liquids because of the tortuous path from one surface of the film to the other.

The amount of dispersed phase particles in the film composition will vary depending on the properties desired, e.g., WTVR, the other components, and the type or types of polymer employed in the polystyrene dispersed phase. Generally, the amount of dispersed phase in the film is at least about 2, preferably at least about 15, more preferably at least about 20 percent by weight of the total composition. Correspondingly, the amount is not more than an amount, which results in co-continuous phases. Generally, the amount employed is less than about 60, preferably less than about 50, more preferably less than about 40 percent by weight of the total composition.

The size of the dispersed particles will also vary depending on the properties desired, e.g., WTVR, the other components, and the type or types of polymer employed in the polystyrene dispersed phase. Generally, in order to maximize WVTR the size of the dispersed particles is from about 1 to about 10 microns and more preferably from about 1 to about 4 microns.

The polystyrene dispersed phase comprises any polymer which will disperse in the polyolefin continuous phase and will form voids when the corresponding film is stretched. Such polymers include polystyrene, polyethylene terephthalate (PET), polybutylene terephthalate, polycarbonate, and mixtures thereof. Thus, the polystyrene dispersed phase may comprise polystyrene, polyethylene terephthalate (PET), polybutylene terephthalate, and polycarbonate alone or in mixtures. The specific type of polystyrene is not particularly limited and includes, for example, GPPS, HIPS, ABS, SAN, styrene block copolymers, and mixtures thereof.

The molecular weight of the polymer or polymer mixture for use in the polystyrene dispersed phase in the present invention is conveniently indicated using a melt flow measurement according to ASTM D-1238, Condition 230° C./2.16 kg (formerly known as “Condition (L)”). Melt flow rate is inversely proportional to the molecular weight of the polymer. Thus, the higher the molecular weight, the lower the melt flow rate, although the relationship is not necessarily linear.

Dispersion of the polystyrene phase in the polyolefin phase is generally related to the viscosity. In the case of the polyolefin continuous phase, viscosity is generally inversely proportional to the melt index. In the case of the polystyrene dispersed phase, viscosity is generally inversely proportional to the melt flow rate. An estimate for comparing polyolefin continuous phase melt index to polystyrene phase's melt flow rate is to divide the polystyrene phase's melt flow rate by 6.5. Thus, a polystyrene phase having a melt flow rate of 3 g/10 min. is somewhat like a polyethylene having a melt index of 0.5 g/10 min., in terms of its viscosity or flow behavior.

Thus, the melt flow rate of the polystyrene dispersed phase useful herein is important in that the ratio of the melt flow rate of the polystyrene dispersed phase to the melt index of the polyolefin continuous phase must be such that the polystyrene is able to form a dispersed, spherical morphology with the particle size in the range described previously. Accordingly, the aforementioned ratio should be less than about 2.5, preferably less than about 2, more preferably less than about 1.2, even more preferably less than about 1.0, most preferably less than about 0.8. Correspondingly, the ratio should not be so low that a film cannot be formed and stretched to form a breathable film. Using the instant specification and examples one skilled in the art can readily achieve the proper morphology and void the material by stretching. One can also determine how much drawing is necessary to cavitate the particles.

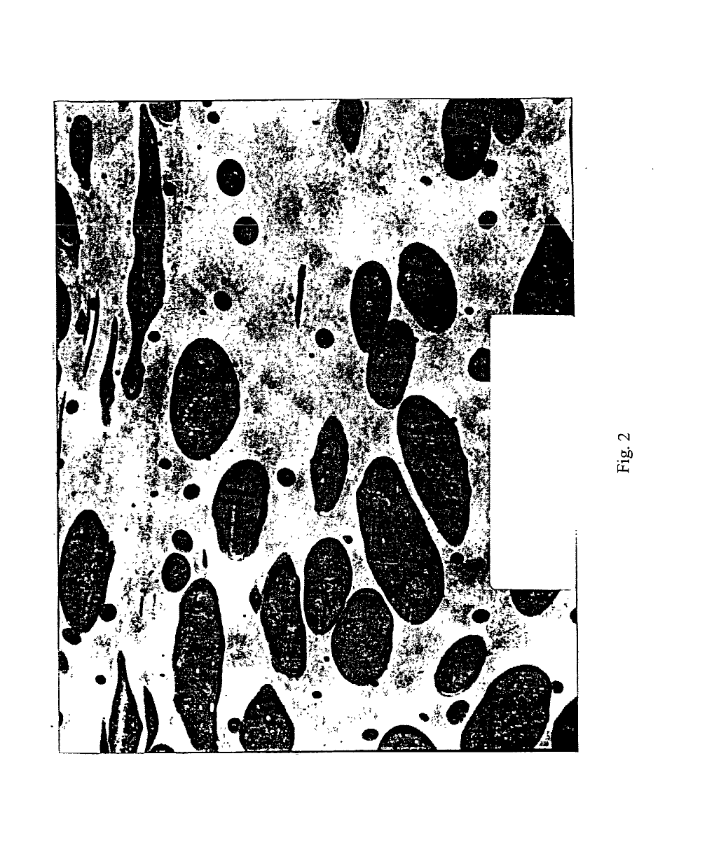

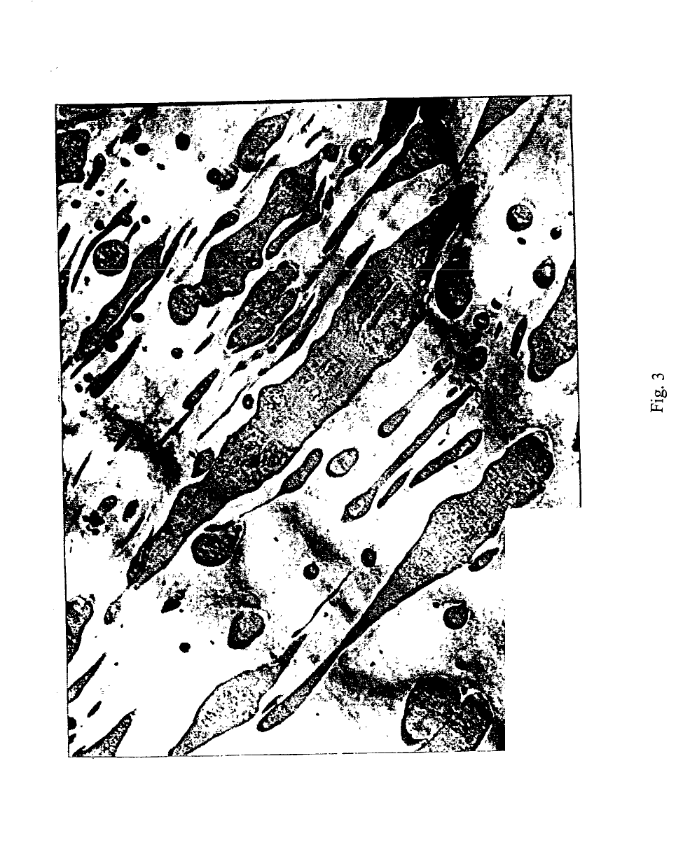

While not wishing to be bound to any particular theory, it is believed that if a majority of the dispersed particles are more spherical and less elliptical, the WVTR of the resulting stretched, film will be increased. This is likely because the stretching of a spherical particle results in a larger void than the stretching of an elliptical particle due to the larger surface area around a spherical particle. A predictor of breathability is thus to take a micrograph in the machine axis direction of the dispersed composition before stretching and examine the length to diameter ratio of the dispersed particles in the cooled phase. Examples of such micrographs are shown in FIGS. 2 and 3. The closer the ratio is to about one, for a majority of the particles then the more likely it is that the composition will exhibit a higher WVTR. For a high WTVR, a preferred length to diameter ratio, i.e. aspect ratio, for a majority of the dispersed particles is less than about 5, preferably less than about 3, more preferably a majority of the dispersed particles have an aspect ratio of from about 1 to about 2.

Polyolefin Continuous Phase

The amount of the polyolefin continuous phase in the film composition will vary depending on the properties desired, e.g., WTVR, the other components, and the type or types of polymer employed. Generally, the amount of continuous phase in the film is at least about 40, preferably at least about 50, more preferably at least about 60 percent by weight of the total composition. Correspondingly, the amount is not so much that there is an inadequate amount of polystyrene dispersed phase. Generally, the amount employed is less than about 98 and preferably less than about 95 percent by weight of the total composition.

The polyolefin continuous phase generally comprises one or more ethylene interpolymers as the major component of the continuous phase. The continuous phase may comprise minor components such as polypropylenes including homopolymers, random, and impact polypropylene copolymers. Other minor components which may comprise the continuous phase include linear low density polyethylene, low density polyethylene, and high density polyethylene.

As described above, it is important that regardless of the specific polyolefin continuous phase composition, the ratio of the of the melt flow rate of the polystyrene dispersed phase to the melt index of the polyolefin continuous phase must be such that randomly dispersed, spherical particles of polystyrene are formed. Thus, the aforementioned ratio should be less than about 2.5, preferably less than about 2, more preferably less than about 1.2, even more preferably less than about 1, and most preferably less than about 0.8. Correspondingly, the ratio should not be so low that a film cannot be formed and stretched to form a breathable film.

Interpolymers which are useful in the present invention as the majority of the polyolefin continuous phase include linear ethylene polymers and substantially linear ethylene polymers. The amount of such polymers, if any, in the composition will vary depending on the properties desired, the other components, and the type of linear or substantially linear polyethylene.

The linear or substantially linear ethylene polymers which may be employed herein are characterized by a density of at least about 0.87, preferably at least about 0.89 g/cm3. Correspondingly, the density is usually less than about 0.96, preferably less than about 0.94 g/cm3.

Another characteristic of the linear or substantially linear ethylene polymers which may be employed herein is, for example, a molecular weight distribution, Mw/Mn of less than or equal to about 5, preferably less than or equal to about 4, and more preferably from about 1.5 to about 4.

Yet another characteristic of the linear or substantially linear ethylene polymer which may be employed herein is a melt index, I2, as measured in accordance with ASTM D-1238, Condition 190° C./2.16 kg of from about 0.5 to about 30.0 dg/min.

It has been discovered that a polyolefin continuous phase comprising linear ethylene polymers or substantially linear ethylene polymers having the aforementioned properties yield stretched film compositions in accordance with the present invention which have surprising and unexpected WVTR without requiring a high density filler or a compatibilizer.

The linear or substantially linear ethylene polymer which may be employed herein may be a homopolymer or copolymer of ethylene with one or more monomers. Preferred monomers or copolymers of ethylene with one or more monomers. Preferred monomers include C3-C8 alpha-olefins such as 1-butene, 1-pentene, 4-methyl-1-pentene 1-hexene, 1-heptene, 1 -octene, and styrene.

The linear ethylene polymer may bean ethylene polymer prepared using a transition metal catalyst, for example, a single site catalyst or a Ziegler-Natta catalyst. The term “linear polymer” comprises both homogeneous linear polymers and heterogeneous linear polymers. By the term “homogenous”, it is meant that any comonomer is randomly distributed within a given interpolymer molecule and substantially all of the interpolymer molecules have the same ethylene/comonomer ratio within that interpolymer. However, unlike heterogeneous polymers, when a homogeneous polymer has a melting peak greater than 115° C. (such as is the case of polymers having a density greater than 0.940 g/cm3), such polymers do not additionally have a distinct lower temperature melting peak.

Further, the homogeneous linear or substantially linear ethylene polymers will lack a measurable high density fraction, (i.e. essentially, linear or homopolymer fraction as measured by Temperature Rising Elution Fractionation which is described in U.S. Pat. No. 5,089,321, and which is incorporated in its entirety into and made a part of this application), e.g. they will not contain any polymer fraction that has a degree of branching less than or equal to 2 methyl/1000 carbons.

The homogeneous linear or substantially linear ethylene polymers are characterized as having a narrow molecular weight distribution (Mw/Mn). For the linear and substantially linear ethylene polymers, the molecular weight distribution, Mw/Mn, is for example, less than or equal to about 5, preferably less than or equal to about 4, and more preferably from about 1.5 to about 4.

The distribution of comonomer branches for the homogeneous linear and substantially linear ethylene polymers is characterized by its SCBDI (Short Chain Branch Distribution Index) or CDBI (Composition Distribution Branch Index) and is defined as the weight percent of the polymer molecules having a comonomer content within 50 percent of the median total molar comonomer content. The CDBI of a polymer is readily calculated from data obtained from techniques known in the art, such as, for example, temperature rising elution fractionation (abbreviated herein as “TREF”) as described, for example, by Wild et al., Journal of Polymer Sciences Poly. Phys. Ed., Vol. 20, p. 441 (1982), or in U.S. Pat. Nos. 4,798,081 and 5,008,204, each of which are incorporated herein by reference. The SCBDI or CDBI for the substantially linear polymers useful in the compositions of the present invention is preferably greater than about 50 percent, especially greater than about 70 percent, more preferably greater than about 90 percent.

Homogeneous linear ethylene/a-olefin interpolymers may be prepared using polymerization processes (e.g., as described by Elston in U.S. Pat. No. 3,645,992, the disclosure of which is incorporated herein by reference) which provide a homogeneous short chain branching distribution. In his polymerization process, Elston uses soluble vanadium catalyst systems to make such polymers. However, others such as Mitsui Petrochemical Company and Exxon Chemical Company have used so-called single site catalyst systems to make polymers having a homogeneous linear structure. Homogeneous linear ethylene/α-olefin interpolymers are currently commercially available from Mitsui Petrochemical Company under the tradename “Tafmer”.

In contrast to homogeneous linear ethylene polymers (which have fewer than 0.01 long chain branches per 1000 carbons), substantially linear ethylene polymers are homogeneous polymers having long chain branching. In particular, as used herein, “substantially linear” means that the polymer backbone is substituted with about 0.01 long-chain branches/1000 carbons to about 3 long-chain branches/1000 carbons, preferably from about 0.01 long-chain branches/1000 carbons to about 1 long-chain branch/1000 carbons, and more preferably from about 0.05 long-chain branches/1000 carbons to about 1, long-chain branch/1000 carbons. Long chain branching is defined in U.S. Pat. No. 5,783,638 incorporated herein by reference.

Long chain branching (LCB) is defined herein as a chain length of at least one (1) carbon less than the number of carbons in the comonomer, whereas short chain branching (SCB) is defined herein as a chain length of the same number of carbons in the residue of the comonomer after it is incorporated into the polymer molecule backbone. For example, an ethylene/1-octene substantially linear polymer has backbones with long chain branches of at least seven (7) carbons in length, but it also has short chain branches of only six (6) carbons in length.

Long chain branching can be distinguished from short chain branching by using 13C nuclear magnetic resonance (NMR) spectroscopy and to a limited extent, e.g., for ethylene homopolymer it can be quantified using the method of Randall (Rev. Macromol. Chem. Phys., C29 (2&3), p. 285-297), the disclosure of which is incorporated herein by reference. However, as a practical matter, current 13C nuclear magnetic resonance spectroscopy cannot. determine the length of along chain branch in excess of about six (6) carbon atoms and as such, this analytical technique cannot distinguish between a seven (7) carbon branch and a seventy (70) carbon branch. The long chain branch can be as long as about the same length as the length of the polymer backbone.

The homogeneous and substantially linear ethylene polymers used in the composition of this invention are known, and they and their method of preparation are fully described in, for example, U.S. Pat. Nos. 5,272,236, 5,278,272, and 5,703,187 all of which are incorporated in their entirety into and made a part of this application.

Methods for determining the amount of long chain branching present, both qualitatively and quantitatively, are known in the art. For qualitative methods for determination, see, e.g., U.S. Pat. Nos. 5,272,236 and 5,278,272, the disclosures of both of which are incorporated herein by reference, which disclose the use of an apparent shear stress vs. apparent shear rate plot to identify melt fracture phenomena.

For quantitative methods for determining the presence of long chain branching, see, e.g., U.S. Pat. Nos. 5,272,236 and 5,278,272; Randall (Rev. Macromol. Chem. Phys., C29 (2&3), p. 285-297), which discusses the measurement of long chain branching using 13C nuclear magnetic resonance spectroscopy, Zimm, G. H. and Stockmayer, W. H., J. Chem. Phys., 17, 1301 (1949); and Rudin, A., Modern Methods of Polymer Characterization, John Wiley & Sons, New York (1991) pp. 103-112, which discuss the use of gel permeation chromatography coupled with a low angle laser light scattering detector (GPC-LALLS) and gel permeation chromatography coupled with a differential viscometer detector (GPC-DV). Each of the these references is incorporated herein by reference.

A. Willem deGroot and P. Steve Chum, both of The Dow Chemical Company, at the Oct. 4, 1994 conference of the Federation of Analytical Chemistry and Spectroscopy Society (FACSS) in St. Louis, Mo., presented data demonstrating that GPC-DV is indeed a useful technique for quantifying the presence of long chain branches in substantially linear ethylene polymers. In particular, deGroot and Chum found that the level of long chain branches in substantially linear ethylene homopolymer samples measured using the Zimm-Stockmayer equation correlated well with the level of long chain branches measured using 13C NMR.

Further, deGroot and Chum found that the presence of octane does not change the hydrodynamic volume of the polyethylene samples in solution and, as such, one can account for the molecular weight increase attributable to octane short chain branches by knowing the mole percent octane in the sample. By deconvoluting the contribution to molecular weight increase attributable to 1 -octene short chain branches, deGroot and Chum showed that GPC-DV may be used to quantify the level of long chain branches in substantially linear ethylene/octane copolymers.

DeGroot and Chum also showed that a plot of Log(I2, melt index) as a function of Log(GPC Weight Average Molecular Weight) as determined by GPC-DV illustrates that the long chain branching aspects (but not the extent of long branching) of substantially linear ethylene polymers are comparable to that of high pressure, highly branched low density polyethylene (LDPE) and are clearly distinct from ethylene polymers produced using Ziegler-type catalysts such as titanium complexes and ordinary homogeneous catalysts such as hafnium' and vanadium complexes.

The “rheological processing index” (PI) is the apparent viscosity (in kpoise) of a polymer measured by a gas extrusion rheometer (GER). The gas extrusion rheometer is described by M. Shida, R. N. Shroff and L. V. Cancio in Polymer Engineering Science, Vol. 17, No. 11, p. 770 (1977), and in “Rheometers for Molten Plastics” by John Dealy, published by Van Nostrand Reinhold Co. (1982) on pp. 97-99, both publications of which are incorporated by reference herein in their entirety. GER experiments are performed at a temperature of 190° C., at nitrogen pressures between 250 to 5500 psig using about a 7.54 cm diameter, 20:1 L/D die with an entrance angle of 180°. For the substantially linear ethylene polymers useful herein, the PI is the apparent viscosity (in kpoise) of a material measured by GER at an apparent shear stress of 2.15×106 dyne/cm2. The substantially linear ethylene polymers useful herein preferably have a PI in the range of about 0.01 kpoise to about 50 kpoise, preferably about 15 kpoise or less. The substantially linear ethylene polymers useful herein have a PI less than or equal to about 70% of the PI of a comparative linear ethylene polymer (either a Ziegler polymerized polymer or a linear uniformly branched polymer as described by Elston in U.S. Pat. No. 3,645,992) at about the same I2 and Mw/Mn.

Substantially linear ethylene polymers will further be characterized as having a resistance to melt fracture. An apparent shear stress versus apparent shear rate plot is used to identify the melt fracture phenomena. According to Ramamurthy in the Journal of Rheology, 30(2), 337-357, 1986, above a certain critical flow rate, the observed extrudate irregularities may be broadly classified into two main types: surface melt fracture and gross melt fracture.

Surface melt fracture occurs under apparently steady flow conditions and ranges in detail from loss of specular film gloss to the more severe form of “sharkskin.” The onset of surface melt fracture (OSMF) is characterized at the beginning of losing extrudate gloss at which the surface roughness of the extrudate can only be detected by 40×magnification. The critical shear rate at the onset of surface melt fracture for the substantially linear ethylene interpolymers and homopolymers is at least 50 percent greater than the critical shear rate at the onset of surface melt fracture of a comparative linear ethylene polymer (either a Ziegler polymerized polymer or a linear uniformly branched polymer as described by Elston in U.S. Pat. No. 3,645,992) having about the same 12 and Mw/Mn.

Gross melt fracture occurs at unsteady extrusion flow conditions and ranges in detail from regular (alternating rough and smooth, helical, etc.) to random distortions. For commercial acceptability, (e.g., in blown films and bags therefrom), surface defects should be minimal, if not absent, for good film quality and properties. The critical shear stress at the onset of gross melt fracture for the substantially linear ethylene polymers used in making the film structures of the present invention is greater than about 4×106 dynes/cm2. The critical shear rate at the onset of surface melt fracture (OSMF) and the onset of gross melt fracture (OGMF) will be used herein based on the changes of surface roughness and configurations of the extrudates extruded by a GER.

The substantially linear ethylene polymers will be characterized as having an I10/I2 (ASTM D-1238), which is greater than or equal to about 5.63, and is preferably from about 6.5 to about 15, more preferably from about 7 to about 10. The molecular weight distribution (Mw/Mn), measured by gel permeation chromatography (GPC), is defined by the equation: Mw/Mn≦(I10/I2)−4.63, and is preferably between about 1.5 and 2.5. For the substantially linear ethylene polymers, the I10/I2 ratio indicates the degree of long-chain branching, i.e. the larger the I10/I2 ratio, the more long-chain branching in the polymer.

Substantially linear ethylene polymers have a highly unexpected flow property, where the I10/I2 value of the polymer is essentially independent of the polydispersity index (i.e., Mw/Mn) of the polymer. This is contrasted with conventional linear homogeneously branched and linear heterogeneously branched polyethylene resins having rheological properties such that to increase the I10/I2 value the polydispersity index must also be increased.

The homogeneous linear or substantially linear ethylene polymer may be suitably prepared using a constrained geometry metal complex, such as are disclosed in U.S. application Ser. No. 545,403, filed Jul. 3, 1990 (EP-A-416,815); U.S. application Ser. No. 702,475, filed May 20, 1991 (EP-A-514,828); as well as U.S. Pat. No. 5,470,993, 5,374,696, 5,231,106, 5,055,438, 5,057,475, 5,096,867, 5,064,802, and 5,132,380. In U.S. application Ser. No. 720,041, filed Jun. 24, 1991, (EP-A-514,828) certain borane derivatives of the foregoing constrained geometry catalysts are disclosed and a method for their preparation taught and claimed. In U.S. Pat. No. 5,453,410 combinations of cationic constrained geometry catalysts with an alumoxane were disclosed as suitable olefin polymerization catalysts. For the teachings contained therein, the aforementioned pending United States Patent applications, issued United States Patents and published European Patent Applications. are incorporated herein by reference.

The heterogeneous linear ethylene polymers are homopolymers of ethylene or copolymers of ethylene and one or more C3 to C8 alpha olefins. Both the molecular weight distribution and the short chain branching distribution, arising from alpha olefin copolymerization, are relatively broad compared to homogeneous linear ethylene polymers. Heterogeneous linear ethylene polymers can be made in a solution, slurry, or gas phase process using a Ziegler-Natta catalyst, and are well known to those skilled in the art. For example, see U.S. Pat. No. 4,339,507, incorporated herein by reference.

Process for Forming the Breathable Films

The breathable films of the present invention may be formed in the following manner. Typically, it is suitable to extrusion blend the components and any additional additives such as slip, anti-block, and polymer processing aids. The extrusion blending should be carried out in a manner such that an adequate degree of dispersion is achieved. The parameters of extrusion blending will necessarily vary depending upon the components. However, typically the total polymer deformation, i.e., mixing degree, is important and is controlled by, for example, the screw-design and the melt temperature.

After extrusion blending, a film structure is formed. Film structures may be made by conventional fabrication techniques, e.g. simple bubble extrusion, biaxial orientation processes (such as tenter frames or double bubble processes), simple cast/sheet extrusion, coextrusion, lamination, etc. Conventional simple bubble extrusion processes (also known as hot blown film processes) are described, for example, in The Encyclopedia of Chemical Technology, Kirk-Othmer, Third Edition, John Wiley & Sons, New York, 1981, Vol. 16, pp. 416-417 and Vol. 18, pp. 191-192, the disclosures of which are incorporated herein by reference. Biaxial orientation film manufacturing processes such as described in the “double bubble” process of U.S. Pat. No. 3,456,044 (Pahlke), and the processes described in U.S. Pat. No. 4,352,849 (Mueller), U.S. Pat. Nos. 4,820,557 and 4,837,084 (both to Warren), U.S. Pat. No. 4,865,902 (Golike et al.), U.S. Pat. No. 4,927,708 (Herran et al.), U.S. Pat. No. 4.952,451 (Mueller), and U.S. Pat. Nos. 4,963,419 and 5,059,481 (both to Lustig et al.), the disclosures of which are incorporated herein by reference, can also be used to make the novel film structures of this invention.

The melt temperature during the film forming varies depending upon the components of the film but is usually in a range which ensures that the elongated morphology relaxes prior to passing through the glass transition temperature of the dispersed polystyrene phase. Generally the melt temperature is from about 175 to about 260, preferably from about 185 to about 240, more preferably between about 195 to about 220 degrees Celsius.

As with all bubble extrusion, the bubble should remain stable. To maintain bubble stability, the blower capacity may be adjusted by adjusting air speed and frostline height (FLH). The blow-up ratio (BUR) and draw-down ratio (DDR) may also be adjusted during the film formation depending upon the components and the melt temperature. Typically, the BUR should be from about 2.5 to about 4.5, preferably from about 2.5. to about 3.7, and more preferably from about 2.8 to about 3.5. Correspondingly, the DDR should be from about 5 to about 25 and preferably from about 15 to about 20. Thus, it may be necessary to adjust parameters of the extruder such as (this affects output rate potential but that can also be achieved more specifically with a different machine), die diameter, and die gap so that the morphology may be adequately controlled during the film formation.

After the film has been formed, it must be stretched. The stretching can be accomplished in any manner so long as the necessary voids are formed in the dispersed phase and the film becomes sufficiently breathable. The stretching parameters which usually control the breathability include temperature, final elongation or draw ratio, and the speed of deformation.

The temperature of stretching should be controlled such that the resulting film permeability is the desired value. Generally, the permeability may be increased by employing a temperature of from about 20 to about 110, preferably from about 50 to about 100, more preferably from about 70 to about 100 degrees Celsius.

The rate of deformation and final elongation should also be controlled such that the resulting film permeability is the desired value. Generally, the permeability may be increased by employing a rate of deformation of from about 50% per minute to about 10000% per minute, preferably from about 100% per minute to about 8000% per minute, more preferably from about 500% per minute to about 5000% per minute. Likewise, permeability may be increased by employing a draw ratio of from about 3 to about 7, preferably from about 4 to about 7, more preferably from about 4.5 to about 5.5.

The breathable films of the aforementioned processes may be made to any thickness depending upon the application. Typically the films have a total thickness of from about 1 to about 5.5, preferably from about 1 to about 4, more preferably from about 1.1 to about 3.5 mils. The permeability may also be adjusted depending upon the application. Typically, the permeability is from about 100 to about 5000 gr/mil/m2/day according to ASTM E96-80 (100° F. 90% relative humidity) or via measurements using a Lyssy L80-4000. The breathable films may be employed in personal care devices such as a backing layer in a diaper. In such a backing layer, the permeability is usually from about 2500 to about 4500 g/mil/m2/day. Said uses are described in detail in WO 99/23139 which is incorporated by reference.

The films and processes of this invention and their use are more fully described by the following examples. Unless indicated to the contrary, all parts and percentages are by weight.

### EXAMPLES

The polymers of the table entitled “Polymers” were utilized in preparing the compositions and films of Examples 1-6 and the comparative examples.

POLYMERS

| | | | Melt Index or Melt | | Melting point (° C.) or |
|---|---|---|---|---|---|
| | | Density | Flow Rate | Mw/ | Vicat Softening |
| Polymer Type | Polymer designation | (g/cm³) | (g/10 min) | Mn | Temperature (° C.) |
| Polyolefin Plastomer (POP) | POLYOLEFIN 1 | 0.895 | 1.6 | 2 | 96 |
| LLDPE | POLYOLEFIN-2 | 0.917 | 4.0 | 3.0 | 123 |
| Polyolefin Plastomer (POP) | POLYOLEFIN-3 | 0.902 | 30 | 2 | 99 |
| LLDPE | POLYOLEFIN-4 | 0.915 | 3.5 | 3.4 | 123 |
| LLDPE** | POLYOLEFIN-5 | 0.915 | 3.5 | N/A | 123 |
| LDPE | POLYOLEFIN-6 | 0.922 | 0.47 | N/A | 112 |
| LDPE | POLYOLEFIN-7 | 0.921 | 7.0 | N/A | 110 |
| Ethylene-Styrene Interpolymer | POLYOLEFIN-8 | 0.94 | 1 | 2 | 107 |
| Ethylene-Styrene Interpolymer | POLYOLEFIN-9 | 0.94 | 30 | 2 | 108 |
| Ethylene-Styrene Interpolymer | POLYOLEFIN-10 | 0.94 | 1 | 2 | 25 |
| Impact-modified polystyrene | POLYSTYRENE-1 | 1.04 | 2.8 | N/A | 101 |
| Impact-modified polystyrene | POLYSTYRENE-2 | 1.04 | 1.1 | N/A | 106 |
| Polystyrene | POLYSTYRENE-3 | 1.04 | 1.5 | N/A | 108 |
| Polystyrene | POLYSTYRENE-4 | 1.04 | 5.5 | N/A | 105 |
| Impact-modified polystyrene | POLYSTYRENE-5 | 1.04 | 8.5 | N/A | 96 |

*Supplied by EXXON/MOBIL Corporation (EXCEED 357C32)

### Example 1

A blend comprising 70% by weight POLYOLEFIN-1 and 30% by weight POLYSTYRENE-1 was mixed using a Brabender W-50 mixing head at a temperature of, 180° C., a rotor speed of 60 revolutions per minute (rpm), and a residence time of 10 minutes.

A film was then compression molded at a plate temperature of 180° C., a pressure of 2000 pounds per square inch gauge (psig), a residence time of 10 minutes, a compression time of one minute, and a cooling rate of 20° C. per minute. The resulting film thickness ranged from 9 to 12 mils (225-300 microns).

The resulting film was stretched on an Instron 5586 test frame at a rate of 100% per minute to a final elongation of 200% in both directions, sequentially. The stretched film was approximately 5.5 mils (140 microns) in thickness. The permeability of the stretched film was 21400 g*mil/m2/day (3900 g/m2/24 hours) as measured according to ASTM E96-80 (100° F., 90% relative humidity).

### Example 2

A dry blend comprising 70% by weight POLYOLEFIN-2 and 30% by weight POLYSTYRENE-2 was dry-blended for ten minutes. Extrusion blending was then employed using a two inch 24:1 two stage screw at 100 rpm with an output of approximately 22 kg/hr and a temperature profile to achieve a melt temperature of 190° C.±10° C. Five passes were employed to disperse the POLYSTYRENE-2.

Extrusion was then employed on a 3% inch Brabender laboratory extruder with a blown film die to produce an output of close to 35 grams/minute. The temperature profile was set to achieve a melt temperature of over 240° C. on a 1 inch (2:54 cm) die and a die gap of 40 mils (1 mm). The BUR employed was 3.0, the DDR employed was 8, and the FLH was approximately 12 cm. A film having a thickness of 5 mils (125 microns) resulted.

The resulting film was stretched uniaxially in the machine direction at a rate of 100% per to a final elongation of 500% in the machine direction. The stretched film was approximately 3.0 mils (75 microns) in thickness. The permeability of the stretched film was 3700 g*mil/m2/day (1250 g/m2/24 hours) as measured according to ASTM E96-80 (100° F., 90% relative humidity).

### Example 3

A dry blend comprising 38.5% by weight POLYOLEFIN-2, 31.5% by weight POLYOLEFIN-3, and 30% by weight POLYSTYRENE-2 was dry-blended for ten minutes. Extrusion blending was then employed using a two inch 24:1 two stage screw at 130 rpm with an output of approximately 26 kg/hr and a temperature profile to achieve a melt temperature of 180° C.±10° C. Five passes were employed to disperse the POLYSTYRENE-2.

Cast film was made on a 3/4 inch Brabender laboratory extruder operating at 60-90 rpm to produce an output of close to 30-35 grams/minute with a cast film line die and associated take-off wherein the temperature profile was set to secure a melt temperature of over 240° C. on the 15 cm wide die and a die gap of 12 mils (250 microns). The final gauge was set at 5 mils by varying chill roll speed and the final film width was approximately 13 cm. The resulting film was stretched at a rate of 100% per minute to a final elongation of 500% in the machine direction. The stretched film was approximately 3.4 mils (85 microns) in thickness. The permeability of the stretched film was 2200 g*mil/m2/day as measured according to ASTM E96-80 (100° F., 90% relative humidity).

### Example 4

### Effect of Draw Ratio

Example 2 was repeated except that POLYSTYRENE-1 was employed instead of POLYSTYRENE-2 to form two resulting films. One resulting film was stretched to a final elongation of 300% in the machine direction at a rate of 100% per minute to yield a stretched film with a final gauge of approximately 4.8 and a permeability of 2200 g*mil/m2/day (670 g/m2/day) as measured according to ASTM E96-80 (100° F., 90% relative humidity). The second resulting film was stretched to a final elongation of 500% in the, machine direction at a rate of 100% per minute to yield a stretched film with a permeability of 3700 g*mil/m2/day (1250 g/m2/day) as measured according to ASTM E96-80 (100° F., 90% relative humidity).

### Example 5

### Effect of Mixing Degree

Example 4 was repeated to prepare two stretched films. The first stretched film had been extrusion blended two times and yielded a stretched film with a permeability of 270 g*mil/m2/day (120 g/m2/day) as measured according to. ASTM E96-80 (100° F., 90% relative humidity). The second stretched film had been extrusion blended three times and yielded a stretched film with a permeability of 1600 g*mil/m2/day (760 g/m2/day) as measured according to ASTM E96-80 (100° F., 90% relative humidity).

### Example 6

### Effect of Stretching Temperature

Blown film comprising 70% by weight POLYOLEFIN-3 and 30% by weight POLYSTYRENE-1 was blown at a temperature of 400° F. and a shear rate of approximately 25s⁻¹ to form two films each having a thickness of 3 mils. One film was stretched at ambient temperature at a rate of 160% per minute to yield a film having a permeability of 160 g*mil/m²/day (130 g/m²/day) as measured according to ASTM E96-80 (100° F., 90% relative humidity). The second film was stretched at a temperature of 90° C. at a rate of 160% per minute to yield a film having a permeability of 5300 g*mil/m²/day (5900 g/m²/day) as measured according to ASTM E96-80 (100° F., 90% relative humidity).

### Example 7

Compounding Procedure

All of the blends were compounded using a Werner-Pfleiderer ZSK-30 mm twin screw extruder made by Krupp. This twin screw extruder is co-rotating and intermeshing with an LID of 32:1. The screw configuration used for this particular project was designed to maximize the amount of dispersion of the polystyrene phase in the polyolefin continuous phase. All of the polymers have been described in the table labeled “POLYMERS.” The blend compositions with weight percentages of the total compositions are shown in Table 3.

TABLE 1
Blend compositions of polyolefin (PO) continuous phase and polystyrene
(PS) dispersed phase with weight percentages.

| | | | | | | | | | Viscosity |
|---|---|---|---|---|---|---|---|---|---|
| Sample | PS-3 | PS-4 | PS-5 | PS-1 | PO-4 | PO-6 | PO = 7 | PO-5 | Ratio of |
| Number, | Wt. % | Wt. % | Wt. % | Wt. % | Wt. % | Wt. % | Wt. % | Wt. % | PO to PS |
| 1 | 30 | | | | 70 | | | | 0.4 |
| 2 | | 30 | | | 70 | | | | 1.7 |
| 3 | | | 30 | | 70 | | | | 2.4 |
| 4 | | | | 20 | 80 | | | | 0.8 |
| 5 | | | | 40 | 60 | | | | 0.8 |
| 6 | | | | 20 | | | | 80 | 0.8 |
| 7 | | | | 30 | | | | 70 | 0.8 |
| 8 | | | | 30 | | 70 | | | 6.0 |
| 9 | | | | 30 | | | 70 | | 0.4 |

PS = Polystyrene
PO = Polyolefin

The temperature profile in the extruder was set to yield a melt temperature between 150 and 180° C. The pellets were then extruded on an EGAN blown film line with a die diameter of 3 inches. The frostline height (FLH), draw down ratio (DDR), blow-up ratio (BUR) and melt temperature were kept relatively constant at 11 inches, DDR of 15, BUR of 2.5, melt temperature of 400° F. The frostline height was kept relatively high to insure sufficient relaxation time for the polystyrene phase prior to crystallization of the polyethylene. Likewise, if the melt temperature is too high, the polystyrene phase remains elongated and results in poor breathability during the secondary-processing step.

Results: Orientation Conditions and WVTR

The films were oriented on an Iwamoto, a lab-scale orientation device capable of inducing both monoaxial and biaxial orientation. The stretching conditions to exhibit relatively high WTVR for the samples shown in Table 1 are given in Table 2. In the case of samples 2, 4, 5, 6, 8, and 9, no samples were collected because the films could not be oriented. Although the viscosity ratio for sample 9 is optimal for increased WVTR, the LDPE/PS films were too brittle to be stretched at any temperature suggesting that the blends are both incompatible and immiscible. The optimal compositional range of polystyrene for increased WVTR is greater than 20 percent polystyrene but less than 40 percent. At a loading of 40 weight percent polystyrene, the matrix approaches co-continuous and the sample cannot be oriented at temperatures optimal for both polyethylene and polystyrene (too high for PE is just right for PS).

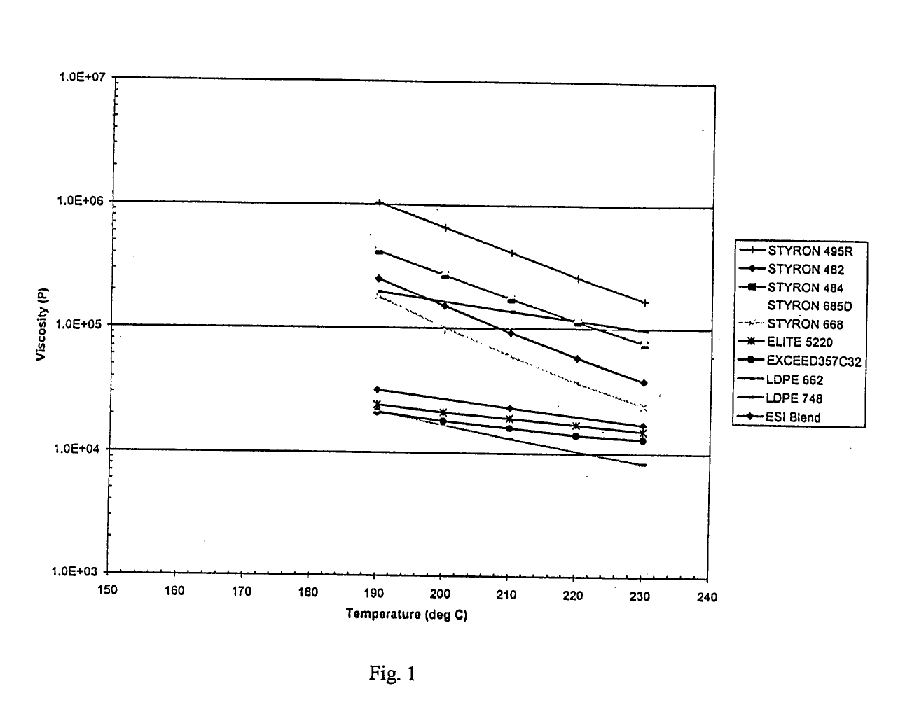

The viscosity as a function of temperature at the approximate blown film extrusion rate of 0.1s−1 is shown in FIG. 1. Sample 1, containing STYRON 685D and ELITE 5520 had a 1.5 order of magnitude difference in viscosity at the extrusion temperature. The WVTR on the film was 1575 g/m2/day. In comparison, the LDPE 668 blend with STYRON 484 was not able to be stretched. The viscosity delta was negligible. However, in the case of LDPE/PS blends, the affect of long chain branching cannot be neglected. The film stiffness and haptics might show that the polystyrene could not be dispersed well in the LDPE. This suggests that the chain microstructure, in particular, the long-chain branches of the LDPE are important in creating the correct morphology. At low shear rates, the long chain branching resist extension and are unlikely to form a continuous matrix around the polystyrene phase.

To examine the effect of the co-monomer, a 70/30 blend of an ethylene-hexene copolymer, EXCEED 357C32 from EXXON/MOBIL with STYRON 484 (Table 3) was compared with sample 10—which employed an ethylene-octene copolymer with the same density and 12 as the EXCEED resin. The resulting WVTR was 2200 g/m2/day, consistent with those results obtained for sample 10.

TABLE 2
Orientation conditions for samples described in Table 1.

| | | Draw Temp., | | WVTR |
|---|---|---|---|---|
| Sample | Draw ratio | ° C. | Rate (mm/s) | (g/m²/day) |
| 1 | 5.2 | 70 | 100 | 1575 |
| 3 | 5 | 70 | 100 | 1000 |
| 7 | 5.2 | 70 | 100 | 2200 |

In order to expand the applicability of this concept, new blends were made for which the viscosity ratio was further reduced. Additionally, the use of a styrene-containing copolymer was also attempted to determine if the styrene functionality acted like a compatibilizer. These blends are shown in Table 3.

TABLE 3
Higher molecular weight polystyrene blends with ethylene-styrene
interpolymers and polyethylene resins.

| | PS-1 | PS2 | PO-8 | PO-10 | PO-9 | PO-2 | PO-4 | Viscosity |
|---|---|---|---|---|---|---|---|---|
| Sample | wt. % | Wt. % | Wt. % | Wt. % | Wt. % | Wt. % | Wt. % | Ratio |
| 10 | 30, | | | | | | 70 | 0.80 |
| 11 | 30 | | 70 | | | | | 2.8 |
| 12 | | 30 | 70 | | | | | 1.1 |
| 13 | | 35 | 65 | | | | | 1.1 |
| 14 | | 35 | | | | 65 | | 0.31 |
| 15 | 35 | | | | | | 65 | 0.80 |
| 16 | | 30 | | | | | 70 | 0.28 |
| 17 | | 35 | | | | | 65 | 0.28 |
| 18 | 30 | | 56 | 14 | | | | 2.8 |
| 19 | 30 | | 25 | 25 | | | | 2.8 |
| 20 | | 30 | 45.5 | | 25.5 | | | 0.80 |

PS = Polystyrene
PO = Polyolefin

The orientation conditions and WVTR for the samples described in Table 3 are shown Table 4.

TABLE 4
Orientation Conditions and WVTR for samples described in Table 5. All
films were originally 4 mils.

| | | Draw Temp., | | WVTR | Thickness |
|---|---|---|---|---|---|
| Sample | Draw ratio | ° C. | Rate (mm/s) | (g/m²/day) | (mils) |
| 10 | 5.5 | 70 | 50 | 2100 | 1.3 |
| 10 | 5.25 | 80 | 50 | 3000 | 1.5 |
| 10 | 5 | 90 | 50 | 3400 | 1.65 |
| 12 | 4 | 80 | 50 | ˜300 | 1.2 |
| 13 | 3 | 80 | 50 | ˜200 | 1.75 |
| 14 | 5.5 | 70 | 50 | 3200 | 1.4 |
| 15 | 5.3 | 70 | 50 | 4100 | 1.2 |
| 16 | 5.3 | 70 | 50 | 1500 | 1.45 |
| 17 | 5.5 | 80 | 50 | 5000 | 1.25 |
| 18 | 3.8 | 90 | 50 | ˜100 | 2 |
| 20 | 4.5 | 70 | 50 | 3400 | 1.1 |

Samples 11 and 19 could not be oriented under the conditions commonly used for the rest of the samples.

Results: Dispersed Phase Morphology

The highest breathability is obtained in systems that include one or more of the following:

1) break up of the polystyrene phase in polyolefin phase occurs during compounding to create good dispersion;

2) viscosity ratio at the fabrication conditions creates spherical dispersed phase morphology (depending upon melt temperature and frostline height or cooling time); and

3) viscosity ratio at extrusion melt temperature is optimized.

Blends showing good dispersion of the polystyrene phase in the polyolefin phase (such as in FIG. 2) generally showed good breathability. The blend of FIG. 2 had a WVTR>3000 g/m²/day believed to be due in part to its spherical morphology created by using a lower melt temperature and higher frostline. In comparison, elongated domains (such as in FIG. 3) generally did not create the cavitated volume necessary for high water vapor transmission. FIG. 3 is the same blend as shown in FIG. 2 but it was extruded at a higher melt temperature and lower frostline height. The WVTR for this sample was <500 g/m²/day.

What is claimed is:

1. A breathable film comprising:
(a) from about 40 to about 98 weight percent of a polyolefin continuous phase; and
(b) from about 2 to about 60 weight percent of a polystyrene dispersed phase; wherein the ratio of the melt flow rate of the polystyrene dispersed phase to the melt index of polyolefin is less than about 2.5.

2. The breathable film of claim 1 wherein the ratio of the melt flow rate of the polystyrene dispersed phase to the melt index of polyolefin is less than about 2.

3. The breathable film of claim 1 wherein the ratio of the melt flow rate of the polystyrene dispersed phase to the melt index of polyolefin is less than about 1.5.

4. The breathable film of claim 1 wherein the ratio of the melt flow rate of the polystyrene dispersed phase to the melt index of polyolefin is less than about 1.2.

5. The breathable film of claim 1 wherein the ratio of the melt flow rate of the polystyrene dispersed phase to the melt index of polyolefin is less than about 1.

6. The breathable film of claim 1 wherein the ratio of the melt flow rate of the polystyrene dispersed phase to the melt index of polyolefin is less than about 0.8.

7. The breathable film of claim 1 wherein the film is characterized by the absence of a wax compatibilizer.

8. The breathable film of claim 1 wherein the film is characterized by the absence of an inorganic filler.

9. The breathable film of claim 1 wherein the dispersed particle size is from about 1 to about 10 microns.

10. The breathable film of claim 1 wherein the dispersed particle size is from about 1 to about 4 microns.

11. The breathable film of claim 10 wherein the length to diameter ratio of a majority of the dispersed particles in a cooled phase is from about 1 to about 2.

12. The breathable film of claim 1 wherein the polyolefin is selected from the group consisting of linear ethylene polymer or substantially linear ethylene polymer characterized by:
(1) a density of from about 0.87 to about 0.96 g/cm³,
(2) a molecular weight distribution, M_{w}/Mₙ, of less than or equal to about 5, and
(3) a melt index, I2, as measured in accordance with ASTM D-1238, Condition 190° C./2.16 kg of from about 0.5 to about 20.0 dg/minute.

13. The breathable film of claim 12 wherein the linear or substantially linear ethylene polymer comprises a copolymer selected from the group consisting of ethylene and 1-octene, ethylene and 1 -butene, ethylene and 1-hexene, ethylene and 1-pentene, ethylene and I -heptene, ethylene and 4 methylpentene-1 and mixtures thereof

14. The breathable film of claim 1 wherein the polystyrene dispersed phase comprises GPPS, HIPS, ABS, SAN, styrene block copolymers, or a mixture thereof.

15. A breathable film comprising:
(a) from about 60 to about 95 weight percent of a polyolefin continuous phase; and
(b) from about 5 to about 40 weight percent of a polystyrene dispersed phase;
wherein the ratio of the melt flow rate of the polystyrene dispersed phase to the melt index of polyolefin is less than about 1.

16. The breathable film of claim 15 wherein the polyolefin continuous phase comprises a copolymer of ethylene and 1-octene, ethylene and 1-butene, or ethylene and 1-hexene, ethylene and 1-pentene, ethylene and 1-heptene, or ethylene and 4 methylpentene-1 or a mixture thereof and wherein the polystyrene dispersed phase comprises GPPS, HIPS, ABS, SAN, styrene block copolymers, or a mixture thereof.

17. The breathable film of claim 15 wherein the dispersed particle size is from about 1 to about 4 microns.

18. The breathable film of claim 15 wherein the film has a permeability of greater than 100 g/mil/m²/dad.

19. A process for forming a breathable film comprising:
(a) blending from about 40 to about 98 weight percent of a polyolefin with from about 2 to about 60 weight percent of a polystyrene wherein the ratio of the melt flow rate of the polystyrene dispersed phase to the melt index of polyolefin is less than about 2 and wherein the blending conditions are sufficient to form a blend comprising a polyolefin continuous phase and a polystyrene dispersed phase;
(b) forming a blown or cast film from the blend; and
(c) stretching said film under conditions sufficient to form said breathable film.

20. The process of claim 19 wherein the blending comprises extrusion blending.

21. The process of claim 19 wherein the polyolefin comprises a copolymer of ethylene and 1 -octene, ethylene and 1 -butene, or ethylene and 1 -hexene, ethylene and 1 -pentene, ethylene and 1-heptene, or ethylene and 4 methylpentene-1 or A mixture thereof and wherein the polystyrene comprises GPPS, HIPS, ABS, SAN, styrene block copolymers, or a mixture thereof.

22. The process of claim 19 wherein the blown or cast film is formed at a melt temperature of from about 175 to about 260° C. a BUR of from about 1.5 to about 4.5, and a DDR of from about 5 to about 25.

23. The process of claim 19 wherein the temperature of stretching is from about 20 to about 110° C.

24. The process of claim 19 wherein the temperature of stretching is from about 70 to about 100° C.

25. A process for forming a breathable film-comprising: .
(a) extrusion blending from about 40 to about 98 weight percent of a polyolefin comprising a copolymer of ethylene and 1-octene, ethylene and 1-butene, or ethylene and 1 -hexene, ethylene and 1 -pentene, ethylene and 1 -heptene, or ethylene and 4 methylpentene-1 or a mixture thereof with from about 2 to about 60 weight percent of a polystyrene comprising GPPS, HIPS, ABS, SAN, styrene block copolymers, or a mixture thereof, wherein the ratio of the melt flow rate of the polystyrene dispersed phase to the melt index of polyolefin is less than about 1 and wherein the blending conditions are sufficient to form an extrusion blend comprising a polyolefin continuous phase and a polystyrene dispersed phase;
(b) forming a blown or cast film from the extrusion blend wherein the film is formed by employing a melt temperature of from about 175 to about 260° C., a BUR of from about 2.5 to about 3.7; and a DDR from about 15 to 20;
(c) stretching said film under conditions sufficient to form said breathable film said conditions comprising an elongation of from about 200 to about 600%, a rate of deformation of from about 50 to about 10000% per minute and a temperature of from about 70 to about 110° C.

26. A personal care device comprising a breathable film wherein said breathable film comprises
(a) from about 40 to about 98 weight percent of a polyolefin continuous phase; and.
(b) from about 2 to about 60 weight percent of a polystyrene dispersed phase;
wherein the ratio of the melt flow rate of the polystyrene dispersed phase to the melt index of polyolefin is less than about 2:

27. The personal care device of claim 26 wherein the breathable film is employed as a backing layer.
